(19) United States
(12) Patent Application Publication
(10) Pub. No.: US 2007/0181540 A1
(43) Pub. Date: Aug. 9, 2007

(54) Method and apparatus for improved plasma arc torch cut quality

(76) Inventor: Jon W. Lindsay, Grantham, NH (US)

Correspondence Address: PROSKAUER ROSE LLP, ONE INTERNATIONAL PLACE 14TH FL, BOSTON, MA, 02110, US

(21) Appl. No.: 11/699,315

(22) Filed: Jan. 29, 2007

Related U.S. Application Data
(60) Provisional application No. 60/762,605, filed on Jan. 27, 2006.

(51) Int. Cl. B23K 9/00

(52) U.S. Cl. 219/121.5

(57) ABSTRACT

Controlling the flow of a secondary gas reduces entrainment of the secondary gas and a plasma gas that forms a plasma arc in a plasma arc torch system. Reducing entrainment of the secondary gas and the plasma gas that forms the plasma arc improves the quality of cuts made with the plasma arc torch.

### RELATED APPLICATION

This application claims the benefit of and priority to and is a non-provisional application of the U.S. provisional patent application entitled “Method and Apparatus for Improved Plasma Arc Torch Cut Quality” filed on Jan. 27, 2006, U.S. Ser. No. 60/762,605, the entirety of which is incorporated by reference herein.

### FIELD OF THE INVENTION

The invention generally relates to the field of plasma arc torch systems and processes. In particular, the invention relates to plasma arc torch systems, operation methods, systems for cutting a material, and methods of controlling a secondary gas in a plasma arc torch.

### BACKGROUND OF THE INVENTION

Plasma arc torches are widely used in the cutting or marking of metallic materials. Generally, an electrode is mounted in a plasma torch, a nozzle with a central exit orifice is mounted within the torch body, the torch includes electrical connections, passages for cooling, arc control fluids, and a power supply. In some embodiments, the torch includes a swirl ring that controls fluid flow patterns in the plasma chamber that is formed between the electrode and nozzle. The torch produces a plasma arc, which is a constricted ionized jet of a plasma gas with high temperature and high momentum. Gases used in the torch can be non-reactive (e.g. argon), or reactive (e.g. oxygen or air).

In operation, for example, in the process of plasma arc cutting a metallic workpiece, a pilot arc is first generated between the electrode (cathode) and the nozzle (anode). Generation of the pilot arc may be by means of a high frequency, high voltage signal coupled to a DC power supply and the torch or any of a variety of contact starting methods. The pilot arc ionizes gas passing through the nozzle exit orifice. After the ionized gas reduces the electrical resistance between the electrode and the workpiece, the arc then transfers from the nozzle to the workpiece. The torch is operated in the transferred plasma arc mode, characterized by the conductive flow of ionized gas from the electrode to the workpiece, for the cutting of the workpiece.

One known configuration of a plasma arc torch includes an electrode and a nozzle mounted in a relationship relative to a secondary cap (also called a shield). The nozzle is surrounded by the secondary cap. A relatively large secondary gas flow (also called a shield gas flow) passes through the space between the nozzle and the secondary cap. The plasma arc flow passes through the nozzle exit orifice along a longitudinal axis, while the secondary gas flow passes through the space between the nozzle and the secondary cap. Often, the secondary gas stream passes through a secondary gas swirl ring that swirls the secondary gas in a certain direction (e.g., clockwise). Generally, the secondary gas flow contacts the plasma gas flow at an interface and this contact can disrupt the plasma arc and thereby cause imperfections in cut quality.

In some embodiments, the secondary gas passes through the space between the nozzle and the secondary cap at an angle relative to the plasma arc longitudinal axis and the secondary flow impinges on the plasma arc flow. After impingement, the secondary gas flow and the plasma arc pass through the secondary cap orifice together. Impingement of the secondary gas on the plasma arc can disrupt the plasma arc and can result in a degraded cutting performance. It is an object of the present invention to provide improved methods of plasma arc torch operation and an improved plasma arc torch that effect the interference of the secondary gas flow with the plasma arc and/or the plasma gas and improve cutting performance.

### SUMMARY OF THE INVENTION

Entrainment is a mass transfer mechanism that occurs when pockets of a secondary gas enter into the plasma arc. Without being bound to a single theory, it is believed that entrainment occurs due to fluid instabilities at the plasma arc-secondary gas interface. Recent research indicates that increased non-uniformity of secondary gas entrainment in a plasma arc leads to increased variation in cut angles. Entrainment of the secondary gas into the plasma gas and/or plasma arc is a function of the density difference between the secondary gas and plasma gas. It appears that the rate of fluid entrainment can also be a function of the orientation, e.g., the angle of and/or of the velocity of, the secondary gas relative to the plasma arc. Thus, it is an object of the invention to control the flow of the secondary gas to provide a secondary gas that reduces and/or minimizes entrainment of the secondary gas into the plasma gas to provide a decreased cut angle variation. In addition, it is desirable for the secondary gas to have adequate thermal conductivity.

In one embodiment, the flow of secondary gas is controlled to provide a secondary gas density that reduces entrainment of the secondary gas into the plasma gas that forms a plasma arc. The secondary gas density can be controlled to reduce entrainment of the secondary gas into the plasma gas by, for example, controlling the secondary gas composition (e.g., where the secondary gas is a mixture of two or more gases) and/or controlling the secondary gas temperature, which controls secondary gas density. Secondary gas entrainment can also be controlled by, for example, selecting torch designs that improve the interface of a secondary gas and a plasma gas that forms a plasma arc.

A controlled secondary gas density that reduces entrainment can reduce cut angle variation, thereby improving the plasma arc torch cut quality. Expected improvements in a material (e.g., a workpiece) cut according to the described methods and that employ the described plasma arc torches include one or more of reduction in surface roughness, reduction in top dross and reduction in top edge rounding. In addition, torches can be designed to direct the flow of the secondary gas through the secondary gas exit orifice at an orientation that reduces entrainment of the secondary gas into the plasma gas.

The invention relates to a plasma cutting torch, methods of operating a plasma (transferred) cutting arc, methods of controlling a secondary gas, and systems for cutting a material that reduce entrainment of the secondary gas flow with the plasma gas that forms the plasma arc thereby improving cutting performance. Generally, the flow of the secondary gas is controlled to reduce entrainment of the secondary gas into the plasma gas at, for example, a location external to a plasma exit orifice located at a first end of the plasma arc torch. The secondary gas can be controlled to provide a secondary gas density that reduces entrainment of the secondary gas into the plasma gas that forms that plasma arc. Generally, when in the cutting mode, the plasma cutting arc is a highly constricted, symmetrical, and stable plasma arc when it exits the nozzle.

For example, in one embodiment, controlling the density of the secondary gas includes controlling the density of the secondary gas flow to reduce the density differential between the plasma gas and the secondary gas in the region of the secondary gas exit orifice. In another embodiment, controlling includes controlling the density of the secondary gas flow to reduce the density differential between the plasma arc and the secondary gas flow when the secondary gas flow contacts the plasma arc. In another embodiment, a system for cutting a material includes a controller for controlling the density of the secondary gas flow to reduce the density differential between the plasma arc extending through a plasma exit orifice and the secondary gas flow when the secondary gas flow contacts the plasma arc.

In still another embodiment, the density of the secondary gas is controlled to provide a secondary gas density that minimizes entrainment of the secondary gas into the plasma gas. For example, the density of the secondary gas flow is controlled to minimize the density differential between the plasma gas and/or the plasma arc and the secondary gas flow.

Systems for cutting a material with a plasma arc torch can include a controller for controlling the density of the secondary gas flow to reduce the density differential between the plasma arc and the secondary gas flow when the secondary gas flow contacts the plasma arc. Suitable controllers can include, in one embodiment, a heater for controlling the temperature of the secondary gas flow. Controlling the temperature of the secondary gas with the heater can reduce entrainment between the secondary gas flow and the plasma arc. Temperature control of the secondary gas can be employed to reduce a density differential between the secondary gas flow and the plasma arc before the secondary gas flow contacts at least a portion of the plasma arc.

In another embodiment, the secondary gas is controlled to reduce the density difference between the plasma gas density and the secondary gas density. In one embodiment, the secondary gas density at ambient conditions is less than the density of Nitrogen gas at ambient conditions. For example, the secondary gas has a density at ambient conditions that is less than about 70% of the density of Nitrogen gas at ambient conditions. The secondary gas is, in one embodiment, a mixture of two or more gases, where, for example, the secondary gas includes at least 20% of an inert gas such as, for example, Helium. In another variation, the secondary gas is less than about 70% of an inert gas such as, for example, Helium.

Controlling the flow of the secondary gas can include directing the flow of the secondary gas through the secondary gas exit orifice at an orientation that reduces entrainment of the secondary gas into the plasma gas. In one embodiment, the orientation that reduces entrainment is an angle at which a secondary gas flows into the plasma arc of the plasma arc torch that is selected to minimize entrainment of the secondary gas into the plasma arc. In some plasma arc torches, the secondary gas stream passes through a secondary gas swirl ring that swirls the secondary gas in a certain direction (e.g., counter-clockwise). Where the secondary gas has passed through a swirl ring the secondary gas stream has at least three directional components: a secondary gas swirl component, a secondary gas axial component, and a secondary gas radial component. In such embodiments, for example, the angle of the secondary gas flow relates to a combination of the secondary gas axial component and the secondary gas radial component. Suitable secondary gas mixtures include, for example, helium.

In one embodiment, the secondary gas exits the secondary gas exit orifice at an angle relative to the longitudinal axis of the plasma arc having a value ranging from about −90° to about 89°, from about 0° to about 89°, from about 0° to about 85°, from about 0° to about 80°, from about 0° to about 75°, or from about 0° to about 50°. In another embodiment, the secondary gas is substantially coaxial to the plasma arc. As such, the secondary gas exits the secondary gas exit orifice at an angle of about 0° relative to the longitudinal axis of the plasma arc. In another embodiment, the secondary gas passage includes one or more fluid passageway in the nozzle. For example, the one or more fluid passageway can define a fluid path of at least a portion of the secondary gas exiting the secondary gas exit orifice. The one or more fluid passageway can generate a converging angular flow with respect to the plasma arc, a diverging angular flow with respect to the plasma arc, and/or be substantially parallel to the plasma arc. The nozzle can define a plasma gas bypass channel. In one embodiment, a portion of the plasma gas exits the plasma arc torch system via the plasma gas bypass channel.

### BRIEF DESCRIPTION OF THE DRAWINGS

The foregoing and other objects, feature and advantages of the invention, as well as the invention itself, will be more fully understood from the following illustrative description, when read together with the accompanying drawings, which are not necessarily to scale.

FIG. 1A is a cross-sectional view of a plasma arc torch.

FIG. 1B is a cross-sectional view of a plasma arc torch having a plasma gas controller and a secondary gas controller.

FIG. 1C is an embodiment of a controller.

FIGS. 2A-2F are views of one or more secondary gas streams flowing at a range of angles relative to a plasma arc illustrated in FIG. 1A.

FIG. 3 is a cross-sectional view of a plasma arc torch tip with one or more secondary gas streams each flowing at an angle relative to the plasma arc.

FIG. 4 is a cross-sectional view of a plasma arc torch tip with one or more secondary gas streams each flowing at an angle relative to the plasma arc.

FIG. 5 is a cross-sectional view of a plasma arc torch tip with one or more secondary gas streams each flowing at an angle relative to the plasma arc.

FIGS. 6A-6F are views of one or more secondary gas streams each flowing through one or more fluid passageway at an angle relative to a plasma arc illustrated in FIG. 1A.

FIG. 7 is a cross-sectional view of a plasma arc torch tip with one or more fluid passageway disposed within the nozzle and one or more secondary gas streams each exiting the exit orifice of a fluid passageway at an angle relative to the plasma arc.

FIG. 8 is a cross-sectional view of a plasma arc torch tip with one or more fluid passageway disposed within the nozzle and one or more secondary gas streams each exiting the exit orifice of a fluid passageway at an angle relative to the plasma arc.

FIG. 9 is a cross-sectional view of a plasma arc torch tip including a circumscribing component forming a part of one or more fluid passageway disposed within the nozzle and one or more secondary gas streams each exiting the exit orifice of a fluid passageway at an angle relative to the plasma arc.

FIG. 9A is a schematic of a plasma arc torch system.

FIG. 10 illustrates a schematic of a plasma arc torch.

FIG. 11 shows cut edges of workpiece plasma arc cut samples.

FIGS. 12A-12C shows through holes cut through a workpiece material.

### DETAILED DESCRIPTION

Plasma cutting commonly is carried out by using a constricted electric arc to heat a gas flow to the plasma state. The energy from the high temperature plasma flow locally melts a workpiece. Suitable workpiece materials include, for example, stainless steel, aluminum, mild steel and/or non-ferrous material. Such plasma cutting processes can include a secondary gas flow, also referred to as a shield gas flow, which is used to protect the torch and assist in the cutting process. Together the momentum of the high temperature plasma flow and the secondary gas flow remove molten material from the workpiece leaving a channel therein known as a cut kerf. Relative motion between the plasma torch and the workpiece allows the process to effectively cut the workpiece.

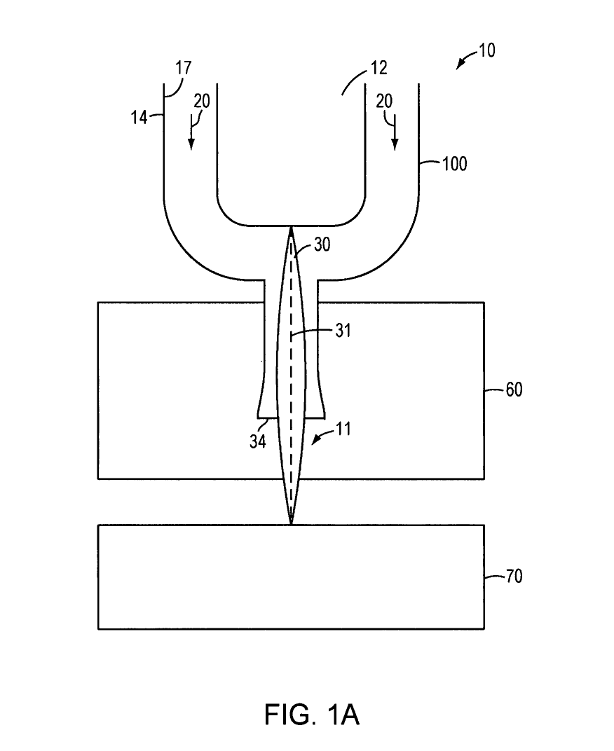

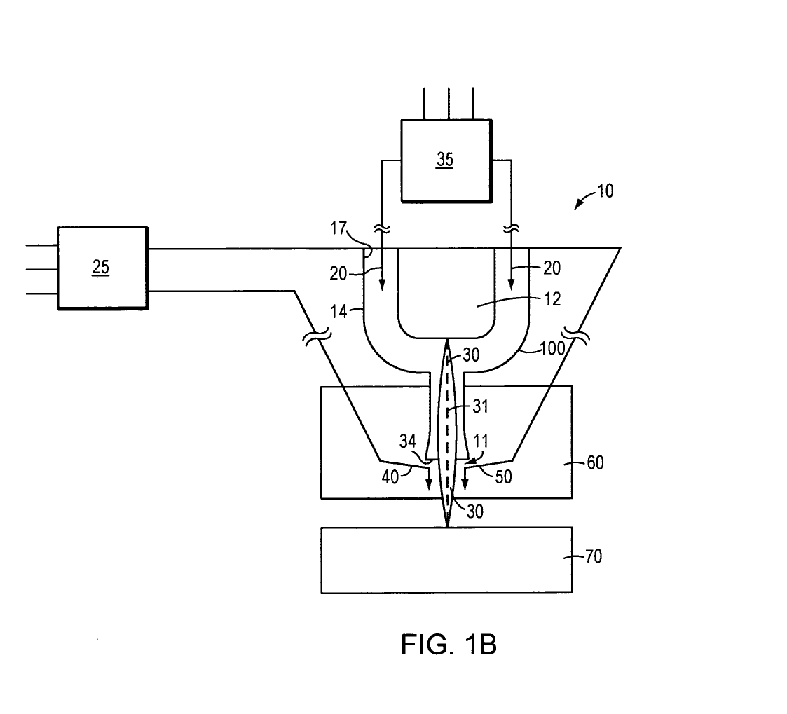

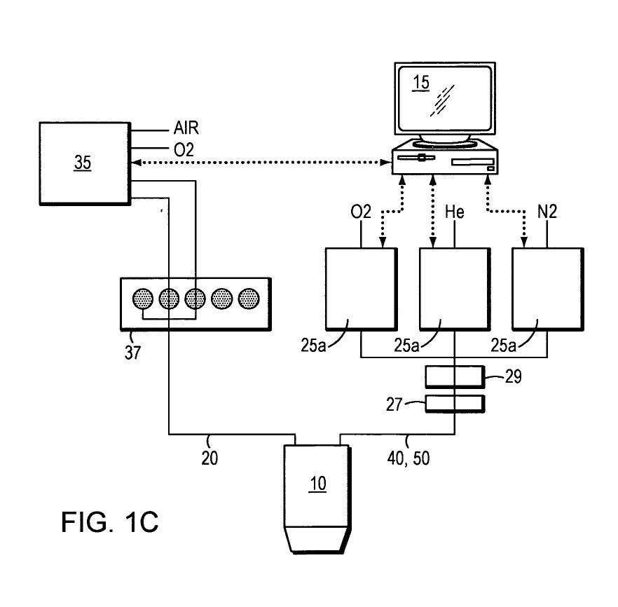

FIG. 1A illustrates a plasma arc torch 10 including a nozzle 14 having a plasma arc exit orifice 34. A plasma arc 30, e.g., an ionized gas jet, exits the torch 10 through the orifice 34 in the torch tip 100 and attaches to a workpiece 70 being processed. The torch 10 is designed to pierce and cut metallic workpieces, particularly mild steel, or other materials in a transferred arc mode. In cutting the workpiece, the torch 10 operates with a fluid, e.g., a plasma gas 20 that forms the transferred plasma arc 30. Generally, when in the cutting mode, the plasma cutting arc 30 is a highly constricted, symmetrical, and stable plasma arc 30 when it exits exit orifice 34 of the nozzle 14.

The plasma arc torch 10 can employ a contact starting process; however, other starting processes can be utilized without departing from the scope of the invention. Briefly, in a contact starting process, the electrode 12 is caused to contact the nozzle 14 creating an electrical short between the electrode and the nozzle. In plasma arc applications, an arc is drawn across a space between an electrode 12 (e.g., a cathode) and the nozzle 14 (e.g., an anode) by establishing a relative electric potential between the electrode 12 and the nozzle 14. The electrode 12 can form at least a portion of a plasma chamber such that the plasma chamber is formed between the electrode 12 and the nozzle 14. In some embodiments, the torch 10 features one or more swirl ring that controls the flow of fluid into the plasma chamber. Plasma arc torches employing swirl rings are disclosed in U.S. Pat. No. 6,207,923, which is incorporated by reference herein. The torch can also include a secondary gas swirl ring to cause the secondary gas stream to swirl. Plasma arc torches employing secondary gas swirl rings are disclosed in U.S. Pat. No. 5,396,043, which is incorporated by reference herein.

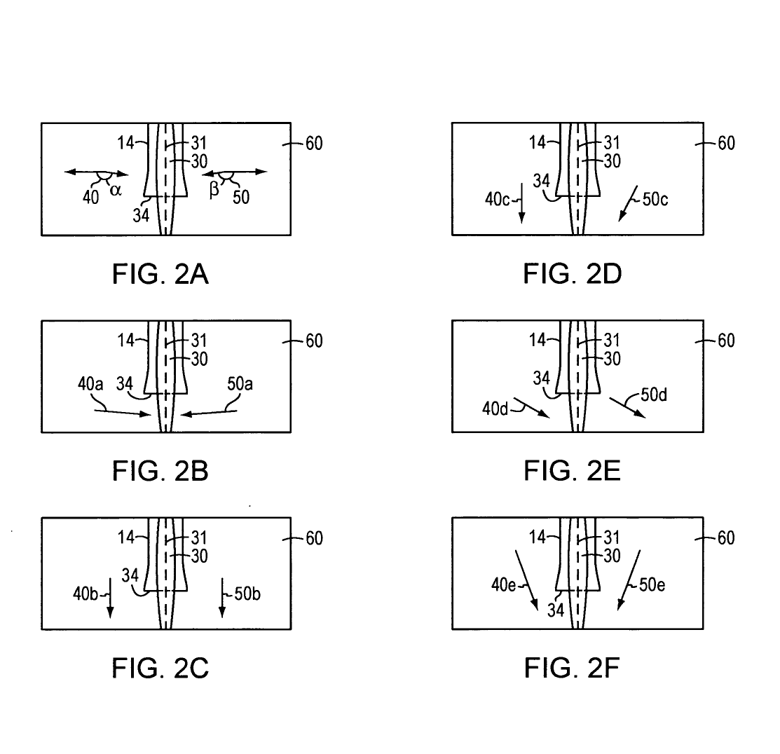

The secondary gas plays a valuable role in the plasma arc cutting process. The secondary gas interacts with the plasma arc 30 and the surface of the workpiece 70. More specifically, the secondary gas is in close contact with and contacts the plasma gas 20 that forms the plasma arc 30. Alternatively, or in addition, the secondary gas is in contact with the workpiece 70. Referring now to FIGS. 1A and 2A and item 60, downstream of the nozzle exit orifice 34, the plasma arc 30 and the secondary gas flow 40 and 50 come into contact enabling heat and mass transfer.

A portion of the secondary gas flow 40, 50 enters the cut kerf with the plasma arc 30 and forms a boundary layer between the cutting arc and the workpiece 70 surface. The composition of this boundary layer (e.g., the thermal conductivity of the boundary layer) influences the heat transfer from the plasma arc 30 to the workpiece 70 surface. In addition, the composition of the boundary layer impacts any chemical reactions that occur between the boundary layer and the workpiece 70 surface.

By selecting suitable secondary gas(es) 40, 50, entrainment of the secondary gas 40, 50 into the plasma gas 20 can be reduced and/or minimized to decrease cut angle variation. Entrainment of the secondary gas 40, 50 into the plasma gas 20 and/or plasma arc 30 is a function of the density differential between the secondary gas 40, 50 (having a relatively higher density) and the plasma gas 20 (having a relatively lower density). Thus, by reducing the density of the secondary gas(es) 40, 50, the density differential between the plasma gas 20 and the secondary gas(es) 40, 50 can be reduced, resulting in reduced entrainment and reduced cut angle variation, surface roughness, top dross and/or top edge rounding. In this way, a controlled secondary gas density can reduce entrainment of the secondary gas with the plasma gas that forms that plasma arc. In order to reduce entrainment, suitable secondary gases 40, 50 have a relatively low density. A secondary gas 40, 50 can be selected according to the gas density and/or thermal conductivity. Alternatively, or in addition, a secondary gas 40, 50 can be exposed to conditions that optimize the gas density and/or the gas thermal conductivity, such as by controlling temperature, for example, through heating.

Generally, suitable secondary gases 40, 50 employed alone or in gas mixtures result in improved gas density and/or thermal conductivity as compared to ambient nitrogen gas. Suitable secondary gas mixtures can include one or more of argon, nitrogen, oxygen, helium, hydrogen, methane, and carbon dioxide. In one embodiment, selection of a secondary gas mixture is made such that the mixture has a density (at ambient conditions) that is less than the density of nitrogen gas at ambient conditions (e.g., nitrogen density measured at ambient temperature and ambient pressure). In another embodiment, the secondary gas at ambient conditions is selected to have a density that is less than about 90%, about 80%, about 70%, about 60%, or about 50% of the density of nitrogen gas at ambient conditions. In one application, the use of one or more inert gas, such as helium, may be preferred because an inert gas retains its atomic state regardless of the temperature conditions to which it is exposed during the plasma arc cutting process. An inert gas does not present a sudden increase in thermal conductivity upon exposure to certain temperatures due, for example, to recombination energy. In contrast, a non-inert (diatomic) nitrogen gas and oxygen gases are not in their atomic state and upon exposure to certain temperature conditions these gases present an increase in thermal conductivity caused by their recombination energies. It is likely that this spike in thermal conductivity impacts cut quality by, for example, causing top edge rounding in, for example, mild steel and aluminum. It is expected that employing an inert gas such as helium as a secondary gas or as part of a secondary gas mixture will improve cut quality by reducing and or minimizing top edge rounding. Use of inert gas(es) in the secondary gas avoids gas reactions that impact thermal conductivity and thereby reduce cut quality.

As discussed above, helium may present desirable characteristics as a secondary gas 40, 50 in the present application. Helium may also present advantages in reducing entrainment between the plasma gas 20 and the secondary gas 40, 50 by reducing the density differential between the plasma gas 20 and the secondary gas 40, 50. Because of its relatively low density, helium may be combined with any number of gases, such as nitrogen, oxygen argon, hydrogen, methane, and carbon dioxide, to create a secondary gas 40, 50 of relatively low density. In such embodiments, the presence of the relatively low density helium lowers the overall all density of the secondary gas 40, 50 mixture. Helium is a low molecular weight gas that has a low density (0.17847 g/L at 0° C.) compared, for example, to the higher density of nitrogen gas (nitrogen gas density 1.251 g/L at 0° C.) or the higher density of oxygen gas (oxygen gas density 1.429 g/L at 0° C.). As such, by combining helium with other gases, the overall density of the secondary gas 40, 50 can be reduced, relative to presently used, helium-free mixtures, and entrainment can likewise be reduced. For example, in a secondary gas containing helium and nitrogen, the overall density of that mixture at ambient conditions would be less than the density of nitrogen in similar conditions. Similarly, the ratio of helium to nitrogen in the secondary gas mixture can be selected to produce a secondary gas 40, 50 having a density less then about 90%, about 80%, about 70%, about 60%, or about 50% of the density of nitrogen (both the secondary gas and nitrogen gas densities being measured at ambient conditions).

In testing combinations of secondary gases, as discussed in greater detail below, secondary gases containing from about 20% to about 80% helium were found to produce noteworthy improvements in cut quality. Secondary gas mixtures containing less than about 20% helium and more than about 80% helium were also found to produce improved cut quality over current systems. Combinations of gases having different helium percentages can range from about 0.01% to about 99.9% helium, from about 0.1% to about 50% helium, from about 5% to about 80% helium, from about 30% to about 70% helium, from about 15% to about 50% helium, or from about 40% to about 60% helium. One of ordinary skill in the art will recognize various combinations and mixtures of gases that could be employed as secondary gas mixtures to reduce the density differential between the plasma arc 30 and the secondary gas 40, 50. In addition, the use of an oxidizing gas in a secondary gas 40, 50 mixture together with a desired amount of helium is desirable in certain cutting applications including, for example, mild steel.

The selection of plasma gas and/or secondary gas can also be guided by the metal contained in the workpiece 70. For example, where the workpiece contains a mild steel the plasma gas is a reactive gas, for example, oxygen or air and the shield gas can be a reactive gas (e.g., Oxygen or Air), a non-reactive gas (e.g., Helium or Nitrogen) or a combination of reactive and non-reactive gases. Suitable shield gases employed with mild steel include, for example, He, a He/N₂ mixture, a H₂/N₂/O₂ mixture, and a H₂/O₂ mixture. In another embodiment, a gas mixture containing 40% He, 50% O₂, and 10% N₂ was found to be effective in cutting mild steel. Where the workpiece contains stainless steel and/or aluminum the plasma gas is a non-oxidizing plasma gas such as, for example, H₃₅ (which contains 35% H₂ and 65% Ar), H₃₅ diluted in N₂, a N₂/Ar/H₂ mixture, a N₂/H₂ mixture containing 95% N₂ and 5% H₂, or N₂. Where the workpiece contains stainless steel and/or aluminum the shield gas can be a non-oxidizing gas such as, for example, Helium or a He/N₂ mixture, such as a mixture of 40% He and 60% N₂.

In another application of the present system, entrainment between the plasma gas 20 and the secondary gas 40, 50 can be reduced by heating the secondary gas 40, 50. As is well understood, the density of a gas is decreased as a function of its temperature or internal energy. In one application, a secondary gas 40, 50 is heated prior to coming in contact with the plasma gas 20, such that the density differential between plasma gas 20 and the secondary gas 40, 50 is reduced. Such secondary gas heating embodiments are not limited to any specific secondary gas or gas combination (e.g., embodiments where the secondary gas is heated can include helium or be free from helium). However, is some applications, the use of an inert gas (e.g., helium) may be desired. Implementations of such heaters will be discussed in greater detail below.

In another embodiment of a plasma arc torch 10, referring to FIGS. 1A-1C, and 2A, the plasma arc 30 is ejected from a plasma exit orifice 34 located at a first end of the plasma arc torch 10. The torch 10 operates with a fluid, e.g., a plasma gas 20 that forms the transferred plasma arc 30. Optionally, the plasma exit orifice 34 is the smallest diameter through which a plasma gas 20 passes in the torch 10 body. The diameter of the plasma exit orifice 34 can be selected based upon the amperage of the torch being used in the cutting process. Plasma arc torches having an amperage ranging from about 15 amps to about 1200 amps, or from about 30 amps to about 400 amps may be employed. In one embodiment, a plasma arc torch with an 80 amp nozzle has a plasma exit orifice measuring 0.046″ in diameter. Torches having an 80 amp nozzle including nozzles manufactured by Hypertherm, Inc. of Hanover, N.H. (part no. 220188) have been found to have an orientation that is effective at reducing and/or minimizing entrainment of the secondary gas in the plasma gas that forms the plasma arc. Of course, those of ordinary skill in the art will recognize many other nozzles and torch components that provide a wide range of plasma exit orifices sizes that can be employed.

Moreover, the plasma arc 30 and the secondary gas flow 40 and 50 can interface and/or intermingle at a location external to the plasma exit orifice 34. For example, in one embodiment, the secondary gas flow 40 and 50 comes into contact with the plasma arc 30 and/or the plasma gas 20 that forms a plasma arc 30 at a location downstream of the plasma exit orifice 34, enabling heat and mass transfer. The plasma arc torch 10 can include a control means for controlling the secondary gas density (e.g., the density of secondary gas 40 and/or 50) such that the secondary gas 40, 50 has a density that reduces entrainment of the secondary gas 40, 50 and the plasma arc 30 at a location external to the plasma exit orifice 34. Suitable control means control the secondary gas 40, 50 to provide a secondary gas 40, 50 that reduces entrainment of the secondary gas 40, 50 and the plasma arc 30 formed by the plasma gas 20.

In one embodiment, the control means controls the density of the secondary gas flow 40, 50 to reduce the density differential between the plasma arc 30 and the secondary gas flow 40, 50 when the secondary gas flow 40, 50 contacts the plasma arc 30. The control means can be a controller 15 (see, FIG. 1C), such as a computer console, that controls the gas flow or mixture of one or more of the plasma gas 20 and the secondary gas 40, 50. In another embodiment, the controller 15 is a control means that controls a plasma gas controller 35 and a secondary gas controller 25a. The controller 15 can be, for example, a system that receives data and signals from and provides signals and data to the plasma gas controller 35 and the torch 10. The plasma gas controller 35 can regulate the flow of plasma gases and can control the composition of the plasma gas. For example, where the workpiece contains stainless steel and/or aluminum the plasma gas controller 35 can regulate the flow of gases to mix a plasma gas from H₃₅ and N₂. The controller 15 can control the plasma gas 20 flow to the torch 10. For example, in one embodiment, the oxygen and/or air travel through the plasma gas controller 35 and through a valve manifold 37 that enables and disables, for example, the flow of the gases to provide a plasma gas 20 to the torch 10. In addition, the controller 15 can receive data and signals from and provide signals and data to the secondary gas controller 25. The controller receives and/or provides cutting signals and gas flow signals, for example.

Referring now to FIG. 1B, in one embodiment, a secondary gas controller 25 is for controlling the density of the secondary gas flow 40, 50. The secondary gas controller 25 controls the flow of a secondary gas 40, 50 to provide a mixture of secondary gases of a density that reduces entrainment of the secondary gas 40, 50 into a plasma gas 20 that forms a plasma arc 30. In one embodiment, the secondary gas controller 25 provides a secondary gas flow 40, 50 having at least about 20% helium gas flow. In one embodiment, the material contains aluminum and/or stainless steel and the secondary gas controller 25 controls the density of the secondary gas to provide a mixture including nitrogen and at least about 20% helium.

The secondary gas controller 25 can, in one embodiment, control the density of the secondary gas flow 40, 50 to reduce the density differential between the plasma gas 20 and the secondary gas 40, 50 at, for example, the secondary gas exit orifice. The secondary gas controller 25 can control the density of the secondary gas flow 40, 50 to reduce the density differential between the plasma arc 30 and the secondary gas 40, 50 at, for example, the secondary gas exit orifice. The controller 25 can control the density of the secondary gas flow 40, 50 to reduce the density differential between the plasma arc 30 and the secondary gas flow when the secondary gas flow 40, 50 contacts the plasma arc 30. Controlling the density of the secondary gas can, in one embodiment, include flowing through the secondary gas exit orifice a secondary gas 40, 50 to minimize the density differential between the secondary gas 40, 50 and the plasma gas 20 at the secondary gas exit orifice. The density of the secondary gases 40, 50 may be measured by suitable means known to the skilled person. In one embodiment, the density of the secondary gases 40, 50 are measured at position 27 after any gas mixture has been combined and prior to entering the plasma arc torch 10. The secondary gas is measured when it is at about ambient pressure and ambient temperature. In another embodiment, the secondary gas 40, 50 is controlled to reduce the density difference between the plasma gas 20 density and the secondary gas 40, 50 density. In one embodiment, the secondary gas is a mixture of two or more gases, at ambient conditions the secondary gas density is less than the density of Nitrogen gas at ambient conditions and the secondary gas includes at least 20% of an inert gas such as, for example, Helium.

In one embodiment, the control means is a flow control module for mixing two or more gases to provide a secondary gas 40, 50. For example, referring now to FIGS. 1A-1C, the secondary gas controller 25a is flow control module for mixing two or more gases (e.g., for mixing two or more of Helium gas, Nitrogen gas, and Oxygen gas). The flow control module can include, for example, valves, mass flow controllers such as, for example, Burkert Mass Flow Controllers (Burkert Contromatic Corp., Irvine, Calif.). The flow control module can provide any range of secondary gas 40, 50 combinations, such a mixture of 40% Helium gas and 60% Oxygen gas. Those having ordinary skill in the art will recognize various methods and systems for metering volumes of gas to reach a desired gas combination. In one embodiment, (see, FIG. 1C) the density of the secondary gas 40, 50 is measured at position 27 after the location at which the two or more gases are mixed by mass flow controllers to provide a secondary gas 40, 50. In one embodiment, the density of the secondary gases 40, 50 are measured at position 27 and when measured the secondary gas 40, 50 is at about ambient pressure and temperature.

For example, recent numerical modeling calculations performed on the Hypertherm HT2000 200A oxygen plasma process indicate that the peak plasma temperature occurs along the centerline of the nozzle bore and this temperature is about 30,000° C. A steep temperature profile exists in the nozzle bore with plasma gas temperatures dropping below 1000° C., the melting point of copper at the nozzle wall. These numerical modeling results show that the highest mass flow rate of the plasma gas in the nozzle bore is located at a radial location only about 0.016 inches from this nozzle wall and the plasma gas has a temperature of approximately 577° C. Shortly after the plasma arc exits the nozzle, the pressure of the oxygen plasma gas drops to atmospheric pressure. At atmospheric pressure and the modeled temperature this region of the plasma gas has a density of 0.46 g/L.

Where the secondary gas is a normal shield gas of air at a temperature of 15° C. and at atmospheric pressure the secondary gas has a higher density, namely a density of 1.225 g/L. There are two basic methods that can be used to reduce the differential between the plasma gas density and the shield gas density. One method involves heating the air shield gas with, for example, an auxiliary heater to a temperature of approximately 480° C. reduces the shield gas density to a density of about 0.46 g/L, which is close to the plasma density provided above. Alternately, the other method involves providing a secondary gas that is a mixture of 27% air and 73% Helium at 15° C. and at atmospheric pressure to provide a secondary gas density of approximately 0.46 g/L. It is contemplated that both methods, providing heat to a standard shield gas of air to provide a reduced density and providing a mixture of gases to achieve a secondary gas having a density substantially similar to the density of the plasma gas can be used in a single plasma arc torch. For example, in one embodiment, a secondary gas including a percentage of inert shield gas can be temperature controlled with, for example, an auxiliary heater to enable a reduction in the quantity of inert gas (e.g., helium) that is employed.

Different applications employ different plasma gases and different shield gases. The secondary gas and the secondary gas density that reduces entrainment of the secondary gas with the plasma arc formed from the plasma gas will be selected based upon a given process. Likewise, the density differential between the secondary gas flow and the plasma gas that forms the plasma arc will be based upon the process and workpiece application. The person of ordinary skill in the art may employ some testing to determine the secondary gas and the secondary gas density that reduces entrainment with the plasma gas that forms a plasma arc.

The plasma gas that forms a plasma arc has a relatively low density that fluctuates depending upon, for example, the temperature, pressure, and point at which the plasma gas that forms a plasma arc is measured. Reducing the density differential between the secondary gas flow 40, 50 and the plasma gas 20 that forms a plasma arc 30 involves providing a secondary gas 40, 50 that has a relatively low density and thereby reduces the density differential between the secondary gas 40, 50 and the plasma gas 20 that forms a plasma arc 30. The density of the secondary gas flow 40, 50 ranges from about 1.0 g/l to about 0.07 g/l, from about 0.8 g/l to about 0.09 g/l, from about 0.6 g/l to about 0.15 g/l, from about 0.4 g/l to about 0.2 g/l, or about 0.3 g/l. The upper range of the secondary gas density is 90% of the density of N₂ at about 15° C. and 1 atmosphere, which measures about 1.09 g/l and the lower range of the secondary gas 40, 50 density measures about 0.0714 g/l, which is the density of helium at about 15° C. and 1 atmosphere. Secondary gases that are currently in use have a larger density differential with a plasma gas that forms a plasma arc and include N₂, which has a density of about 1.215 g/l measured at about 15° C. and 1 atmosphere, Air, which has a density of about 1.226 g/l measured at about 15° C. and 1 atmosphere, and O₂, which has a density of about 1.388 g/l measured at about 15° C. and 1 atmosphere.

In one embodiment, (see, FIG. 1C) the control means is a temperature controller that controls the temperature of the secondary gas flow 40, 50. The secondary gas controller 25 can include a temperature controller, for example, a heater 29. In one embodiment, a secondary gas 40, 50 is pre-heated by a heater 29 that is external to the torch 10 prior to when the secondary gas 40, 50 contacts the plasma arc 30. In another embodiment, a heater (e.g., an auxiliary heater) is disposed on the torch 10. Suitable heaters that may be employed include, for example, in-line air heaters such as those manufactured by Omega, Inc. under the Omegalux name (model nos. AHP-3742, AHP-5052, AHP-7562). The secondary gas controller 25 can, for example, maintain the temperature of the secondary gas flow. By optimizing the temperature of the secondary gas 40, 50, for example, by heating the secondary gas 40, 50, the secondary gas 40, 50 density is reduced and its thermal conductivity is increased. In one embodiment, the density of the secondary gases 40, 50 are measured at position 27, which is after the gas mixture has been combined and the temperature has been controlled by the heater 29 and prior to entering the plasma arc torch 10. When the temperature controlled secondary gas 40, 50 is measured it is about ambient pressure. The secondary gas 40, 50 temperature can be impacted by heat exchanged within the torch 10 body, however, in some embodiments, the secondary gas density is determined upstream of the plasma arc torch (e.g., before the secondary gas 40, 50 flow enters the plasma arc torch 10). The anticipated impact of heat transfer within the plasma arc torch 10 on the secondary gases 40, 50 can be employed in determining the desired secondary gas 40, 50 density range, for example, the temperature level of the secondary gas 40, 50 exiting the heater 29 can anticipate additional heat exchange that will take place in the plasma arc torch 10.

In some embodiments, referring still to FIGS. 1A-1C, the secondary gas 40, 50 has a temperature that differs from the temperature of the plasma arc 30. For example, the secondary gas 40, 50 can have a lower temperature than the plasma arc 30 (e.g., the secondary gas 40, 50 has a colder temperature than the plasma arc 30 at the interface of the secondary gas 40, 50 and the plasma arc 30). In many cutting torches the secondary gas flow 40, 50 is used to cool or assist in nozzle 14 cooling. When the secondary gas 40, 50 is employed as a nozzle cooling fluid, the secondary gas flow 40, 50 is indirectly pre heated by the plasma arc torch 10 and/or the plasma arc 30. In one embodiment, the secondary gas flow 40, 50 is temperature controlled by an additional energy source, for example, the secondary gas 40, 50 is pre-heated by an additional energy source (e.g., a heater 29) to reach an elevated secondary gas temperature prior to contacting the plasma arc 30. One stream of secondary gas (e.g., 40) can have a temperature that is different from another stream of secondary gas (e.g., 50) that contacts the plasma arc 30. For example, one stream of secondary gas 40 can be pre-heated by an additional energy source and another stream of secondary gas 50 is provided at ambient temperature. The secondary gas stream can be provided at ambient temperature or at a temperature above or higher than ambient temperature. The secondary gas temperature can have a value within the range of from about ambient temperature to about 30,000° C., or from about ambient temperature to about 3,000° C., or from about ambient temperature to about 1,000° C., or from about ambient temperature to about 500° C., or from about 500° C. to about 1000° C., for example. The secondary gas 40, 50 temperature can be measured at position 27, for example.

Research indicates increased non-uniformity of secondary gas entrainment increases workpiece cut angle variation. Thus, controlling secondary gas 40, 50 entrainment in the plasma arc 30 is expected to decrease cut angle variation thereby improving plasma arc torch cut quality. Expected improvements include, for example, reduction in surface roughness, reduction in top dross and reduction top edge rounding in the finished workpiece.

Cut angle variation is evaluated by examining a cut edge of workpiece cut with a plasma arc. A cut is viewed along the horizontal axis and where no cut angle variation is present the cut edge is at a 90° angle along the vertical axis. It is expected that reduced cut angle variation can be achieved by selecting torch designs that improve the interface of a secondary gas 40, 50 and the plasma arc 30. In one embodiment, controlling the flow of the secondary gas 40, 50 includes directing the flow of the secondary gas 40, 50 through the secondary gas exit orifice at an orientation that reduces entrainment of the secondary gas 40, 50 into the plasma gas 20.

The control means can also controlling the flow of the secondary gas 40, 50 through a secondary gas exit orifice at an orientation (e.g., an angle) that reduces entrainment of the secondary gas 40, 50 into the plasma arc 30. FIGS. 1A and 2A illustrate a method of operating a plasma arc torch system. The method includes flowing a plasma gas 20 that forms a plasma arc 30 that extends from an end of electrode 12. The plasma arc 30 extends through the plasma exit orifice 34 of the nozzle 14. The plasma arc 30 has a longitudinal axis 31 and the plasma arc flows about the plasma arc longitudinal axis 31. The torch 10 has a secondary gas passage including a secondary gas exit orifice. The method also includes flowing a secondary gas 40, 50 through a secondary gas exit orifice at an orientation (e.g., an angle) that reduces entrainment of the secondary gas 40, 50 into the plasma arc 30. In one embodiment, the secondary gas 40, 50 includes helium. Referring now to FIG. 2A, the secondary gas 40 exits the secondary gas exit orifice at an angle α relative to the plasma arc 30 longitudinal axis 31. The angle α has a value that ranges from about 89° to about −90°, from about 0° to about 89°, from about 0° to about 80°, from about 0° to about 75°, or from about 0° to about 50°. Similarly, the secondary gas 50 exits the secondary gas exit orifice at an angle β relative to the plasma arc 30 longitudinal axis 31. The angle β has a value that ranges from about 89° to about −90°, from about 0° to about 89°, from about 0° to about 80°, from about 0° to about 75°, or from about 0° to about 50°. Any of a number of torch, torch tip, and/or exit orifice configurations that provide one secondary gas flow 40, 50 at one or more value within the range of angles α, β relative to the plasma arc 30 longitudinal axis 31 are contemplated by the invention.

Referring now to FIGS. 1A and 2B, the secondary gas 40a, 50a flows through and exits the secondary gas exit orifice at an angle having a value ranging from about 89° to about 75°, more specifically, from about 87° to about 80°, more specifically, at an angle of about 85° relative to the plasma arc 30 longitudinal axis 31. Where the secondary gas has passed through a swirl ring, for example, the secondary gas stream has at least three directional components: a secondary gas swirl component, a secondary gas axial component, and a secondary gas radial component. In such embodiments, for example, the angle of the secondary gas flow that is shown as secondary gas stream 40a, 50a relates to a combination of the secondary gas axial component and the secondary gas radial component. The secondary gas swirl component is not reflected in the secondary gas streams 40a, 50a illustrated in FIG. 2B and this convention follows for the secondary gas streams as illustrated and described herein.

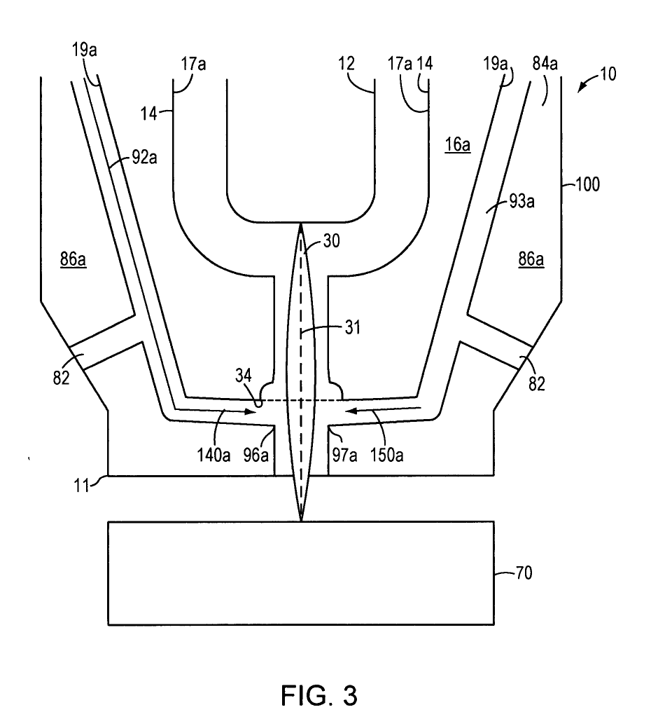

FIG. 3 illustrates an embodiment of a tip 100 of a plasma arc torch 10 where the secondary gas 140a, 150a exits the secondary gas exit orifice 96a, 97a at an angle having a value ranging from about 89° to about 75°, more specifically, from about 87° to about 80°, more specifically, at an angle of about 85° relative to the longitudinal axis 31 of the plasma arc 30. Referring still to FIG. 3, the components of the torch tip 100 include the nozzle 14, which includes a nozzle body 16, a substantially hollow nozzle interior 17a, a nozzle exterior 19a, and a plasma exit orifice 34. The nozzle 14 can define a plasma gas bypass channel. In one embodiment, a portion of the plasma gas exits the plasma arc torch system via a plasma gas bypass channel. The electrode 12 contacts the nozzle 14 creating an electrical short between the electrode 12 and the nozzle 14. A plasma arc 30 is drawn across a space between the electrode 12 and the nozzle 14. The plasma arc 30 exits the plasma exit orifice 34. A secondary cap 84a has a body 86a and optionally has vent holes 82 through which all or a portion of the secondary gas can be vented from the torch tip 100. The secondary cap 84a is mounted in a mutually spaced relationship with the nozzle exterior 19a. The nozzle exterior 19a and the secondary cap 84a form a secondary gas passage 92a, 93a. The secondary gas passage 92a, 93a includes a secondary gas exit orifice 96a, 97a. The secondary gas 140a exits the secondary gas exit orifice 96a at an angle that reduces entrainment of the secondary gas 140a into the plasma arc 30. Similarly, the secondary gas 150a exits the secondary gas exit orifice 97a at an angle that reduces entrainment of the secondary gas 150a into the plasma arc 30. In one embodiment, the secondary gas 150a exits the secondary gas exit orifice 97a at an angle that measures about 85° relative to the longitudinal axis 31 of the plasma arc 30. The secondary gas exit orifice 96a, 97a is located about where the gap between the nozzle 14 and the secondary cap 84a (e.g., the secondary gas passage 92a, 93a) ends 96a, 97a and is no longer defined. The direction (e.g., the angle) at which the secondary gas flows from the secondary gas exit orifice 96a, 97a before it contacts the plasma arc 30 is measured.

In FIG. 3, the secondary gas 140a, 150a flows through the secondary gas exit orifice at an angle relative to the longitudinal axis 31 of the plasma arc 30 in a manner similar to the secondary gas in FIG. 2B. The torch tip 10 shown in FIG. 3 is a non-limiting example and any of a number of torch, torch tip, and/or exit orifice configurations that provide the angle of secondary gas flow 40a, 50a (see FIG. 2B) relative to the plasma arc 30 are contemplated by the invention. While the cross section of the torch tip 100 in FIG. 3 shows two secondary gas passages 92a, 93a, any suitable number of secondary gas passages may be employed. The number and/or size of each secondary gas passage may be selected according to the specific application (e.g., the torch, plasma arc, secondary gas, secondary gas temperature, and/or workpiece size and material can be considered when selecting the number and/or size of secondary gas passages).

Referring now to FIGS. 1A and 2C, the secondary gas 40b, 50b flows through a secondary gas exit orifice at an angle of about 0° relative to the longitudinal axis 31 of the plasma arc 30. Thus, the secondary gas 40b, 50b is substantially coaxial to the plasma arc 30. The secondary gas 40b, 50b is substantially columnar relative to the plasma arc 30. The coaxial or parallel secondary gas streams 40b, 50b are expected to reduce and/or minimize entrainment of the secondary gas 40b, 50b into the plasma arc.

Referring now to FIGS. 1A and 2D, the secondary gas stream 40c flows through its secondary gas exit orifice at an angle of about 0° relative to the longitudinal axis 31 of the plasma arc 30 and secondary gas 50c flows through its secondary gas exit orifice at an angle having a value ranging from about 5° to about 25° relative to the longitudinal axis 31 of the plasma arc 30.

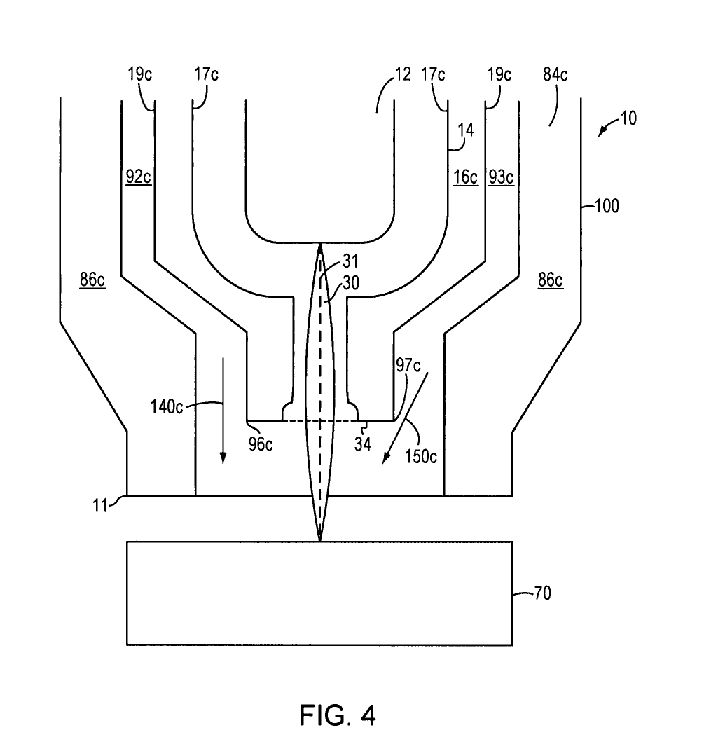

FIG. 4, illustrates an embodiment of a tip 100 of a plasma arc torch 10 where the secondary gas streams 140c, 150c flow through secondary gas passages 92c, 93c and exit secondary gas exit orifices 96c, 97c, respectively. Secondary gas 140c exits orifice 96c at an angle of about 0° relative to the longitudinal axis 31 of the plasma arc 30 and secondary gas 150c exits orifice 97c at an angle having a value ranging from about 5° to about 25° relative to the longitudinal axis 31. Referring still to FIG. 4, the components of the torch tip 100 include the nozzle 14, which includes a nozzle body 16c, a substantially hollow nozzle interior 17c, a nozzle exterior 19c, and a plasma exit orifice 34. A plasma arc 30 is drawn across a space between the electrode 12 and the nozzle 14. The plasma arc 30 exits the plasma exit orifice 34. A secondary cap 84c has a body 86c. The secondary cap 84c is mounted in a mutually spaced relationship with the nozzle exterior 19c to form a secondary gas passage 92c, 93c. The secondary gas passage 92c, 93c includes a secondary gas exit orifice 96c, 97c. The secondary gas 140c exits the secondary gas exit orifice 96c at an angle that reduces entrainment of the secondary gas 140c into the plasma arc 30. Similarly, the secondary gas 150c exits the secondary gas exit orifice 97c at an angle that reduces entrainment of the secondary gas 150c into the plasma arc 30. In one embodiment, the secondary gas 150c exits the secondary gas exit orifice 97c at an angle that measures from about 5° to about 25° relative to the longitudinal axis 31 of the plasma arc 30 and the secondary gas 140c exits the secondary gas exit orifice 96c at an angle of about 0° relative to the longitudinal axis 31. In FIG. 4, the secondary gas 140c, 150c flows through the secondary gas exit orifice at an angle relative to the longitudinal axis 31 of the plasma arc 30 in a manner similar to the secondary gas in FIG. 2D. The torch tip 10 shown in FIG. 4 is a non-limiting example and any of a number of torch, torch tip, and/or exit orifice configurations that provide the angle of secondary gas flow 40c, 50c (see FIG. 2D) relative to the plasma arc 30 are contemplated by the invention.

Referring now to FIGS. 1A and 2E, the secondary gas stream 40d flows through its secondary gas exit orifice an angle of from about 50° to about 80° relative to the longitudinal axis 31 of the plasma arc 30. The secondary gas 50d flows through its secondary gas exit orifice an angle of from about −50° to about −80° relative to the longitudinal axis 31. In accordance with this embodiment, the secondary gas stream 40d provides a converging angular flow with respect to the plasma arc 30 and the secondary gas stream 50d provides a diverging angular flow with respect to the plasma arc 30.

Referring now to FIGS. 1A and 2F, each of the secondary gas streams 40e, 50e flow through their respective secondary gas exit orifices at an angle of from about 40° to about 50° relative to the longitudinal axis 31 of the plasma arc. In accordance with this embodiment, each of the secondary gas streams 40e, 50e provide a converging angular flow with respect to the plasma arc 30.

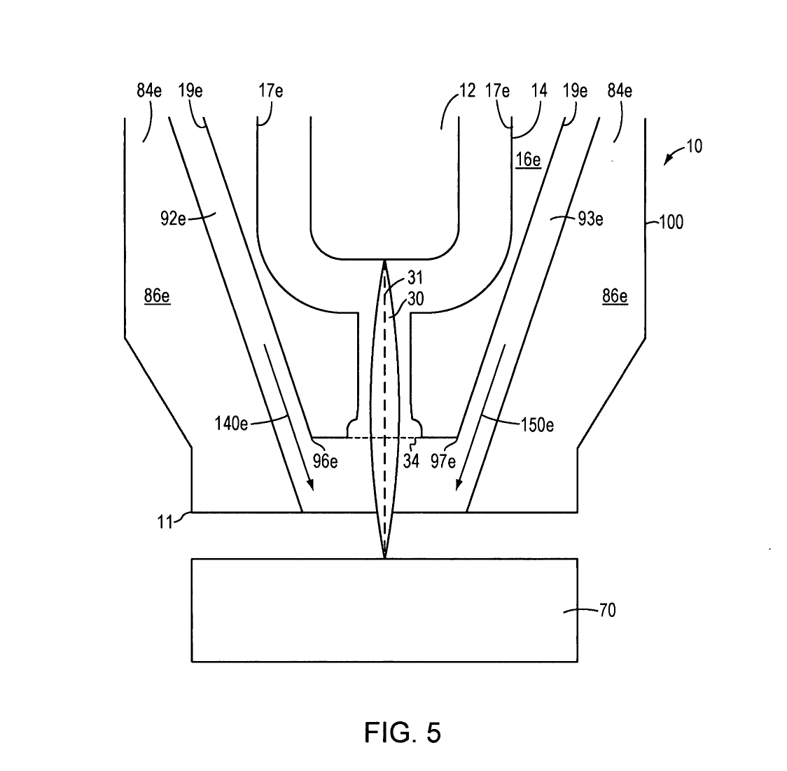

FIG. 5, illustrates an embodiment of a tip 100 of a plasma arc torch 10 where the secondary gas streams 140e, 150e flow through secondary gas passages 92e, 93e and exit secondary gas exit orifices 96e, 97e, respectively. Secondary gas 140e exits orifice 96e at an angle of from about 40° to about 50° relative to the longitudinal axis 31 of the plasma arc 30 and secondary gas 150e exits orifice 97e at an angle having a value ranging from about 40° to about 50° relative to the longitudinal axis 31.

Referring still to FIG. 5, the components of the torch tip 100 include the nozzle 14, which includes a nozzle body 16e, a substantially hollow nozzle interior 17e, a nozzle exterior 19e, and a plasma exit orifice 34. A plasma arc 30 is drawn across a space between the electrode 12 and the nozzle 14. The plasma arc 30 exits the plasma exit orifice 34. A secondary cap 84e has a body 86e. The secondary cap 84e is mounted in a mutually spaced relationship with the nozzle exterior 19e to form a secondary gas passage 92e, 93e. The secondary gas passage 92e, 93e includes a secondary gas exit orifice 96e, 97e. The secondary gas 140e exits the secondary gas exit orifice 96e at an angle that reduces entrainment of the secondary gas 140e into the plasma arc 30. Similarly, the secondary gas 150e exits the secondary gas exit orifice 97e at an angle that reduces entrainment of the secondary gas 150e into the plasma arc 30. In one embodiment, the secondary gas 150e exits the secondary gas exit orifice 97e at an angle having a value ranging from about 40° to about 50° relative to the longitudinal axis 31 of the plasma arc 30 and the secondary gas 140e exits the secondary gas exit orifice 96e at an angle having a value ranging from about 40° to about 50° relative to the longitudinal axis 31. In FIG. 5, the secondary gas 140e, 150e flows through the secondary gas exit orifice 96e, 97e at an angle relative to the longitudinal axis 31 of the plasma arc 30 in a manner similar to the secondary gas in FIG. 2F. The torch tip 10 shown in FIG. 5 is a non-limiting example and any of a number of torch, torch tip, and/or exit orifice configurations that provide the angle of secondary gas flow 40e, 50e (see FIG. 2F) relative to the plasma arc 30 are contemplated by the invention.

In another embodiment, the nozzle 14 can include a substantially hollow nozzle interior and a nozzle exterior. Optionally, the nozzle exterior defines one or more grooves. The method can include a secondary cap mounted in a mutually spaced relationship to the nozzle exterior to form one or more secondary gas passage between the one or more grooves and the secondary cap (not shown). For example, in one embodiment, the nozzle exterior defines one or more grooves and when the secondary cap is mounted flush with the nozzle exterior the one or more grooves form one or more secondary gas passage.

In still another embodiment, the secondary gas passage includes one or more fluid passageway in the plasma arc torch nozzle. For example, the one or more fluid passageway can define a fluid path of at least a portion of the secondary gas exiting the secondary gas exit orifice. The one or more fluid passageway can generate a converging angular flow with respect to the plasma arc, a diverging angular flow with respect to the plasma arc, and/or be substantially parallel to the plasma arc. Embodiments employing one or more fluid passageway in the nozzle are described with respect to figures including, for example, FIGS. 1A, 6A-6F, and 7-9. Plasma arc torches and nozzles in which fluid passageways are disposed in a nozzle are described in U.S. Ser. Nos. 60/680,184 and 11/432,282, which are incorporated by reference herein.

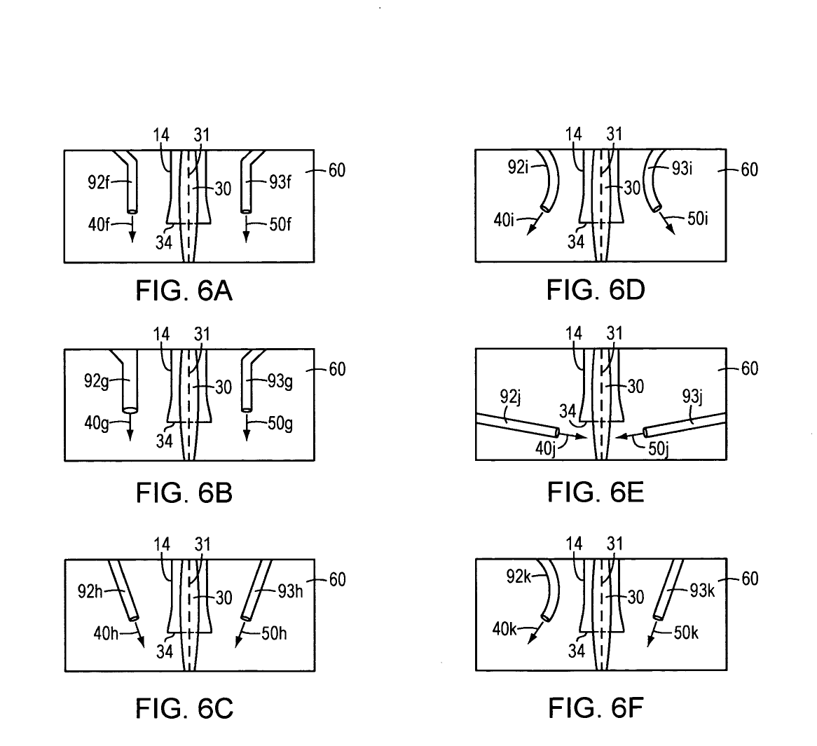

Referring now to FIGS. 1A and 6A, each of the secondary gas streams 40f, 50f flow through and exit a secondary gas exit orifice at an angle of about 0° relative to the longitudinal axis 31 of the plasma arc 30. Thus, the secondary gas 40f, 50f is substantially coaxial to the plasma arc 30. Further, the secondary gas 40f, 50f is substantially columnar relative to the plasma arc 30. More specifically, each of the secondary gas streams 40f, 50f flow through a secondary gas passage 92f, 93f and exits a secondary gas exit orifice. The coaxial or parallel secondary gas 40f, 50f is expected to reduce and/or minimize entrainment of the secondary gas 40f, 50f into the plasma arc 30.

Similarly, referring now to FIGS. 1A and 6B, each of the secondary gas streams 40g, 50g flow through and exit a secondary gas exit orifice at an angle of about 0° relative to the longitudinal axis 31 of the plasma arc 30. Accordingly, each of the secondary gas streams 40g, 50g is substantially coaxial to the plasma arc 30. The secondary gas 40g, 50g is substantially columnar relative to the plasma arc 30. More specifically, each of the secondary gas streams 40g, 50g flows through a secondary gas passage 92g, 93g and exits a secondary gas exit orifice. The secondary gas streams 40g, 50g are expected to reduce and/or minimize entrainment of the secondary gas 40g, 50g into the plasma arc 30.

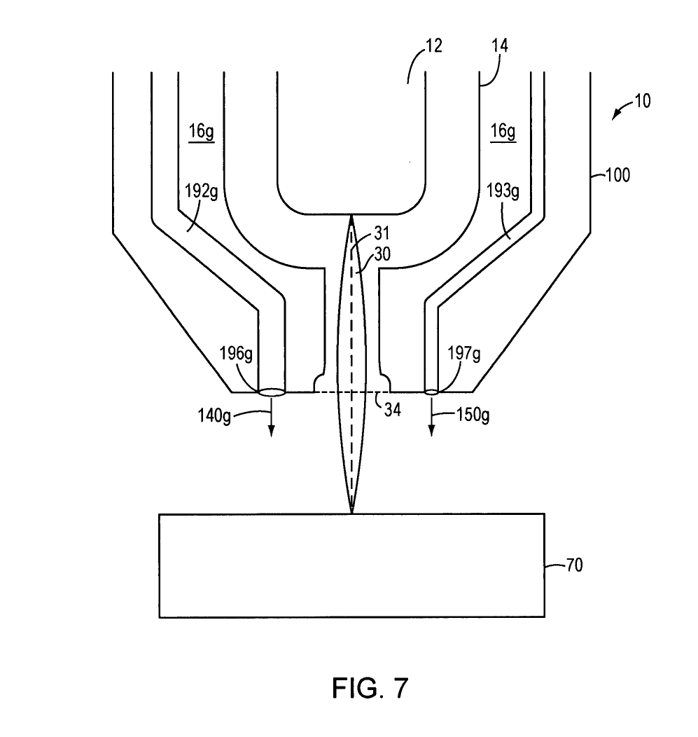

FIG. 7, illustrates an embodiment of a tip 100 of a plasma arc torch 10 where the secondary gas streams 140g, 150g flow through secondary gas passages 192g, 193g and exit secondary gas exit orifices 196g, 197g, respectively. Secondary gas 140g exits orifice 196g at an angle of about 0° relative to the longitudinal axis 31 of the plasma arc 30 and secondary gas 150g exits orifice 197g at an angle of about 0° relative to the longitudinal axis 31 . Referring still to FIG. 7, the components of the torch tip 100 include the nozzle 14, which includes a nozzle body 16g, fluid passageways 192g, 193g disposed in the nozzle body 16g that provide secondary gas passages disposed within the nozzle body 16g, and a plasma exit orifice 34. The plasma arc 30 exits the plasma exit orifice 34. Each secondary gas passage 192g, 193g (i.e., fluid passageway) includes a secondary gas exit orifice 196g, 197g. The secondary gas 140g exits the secondary gas exit orifice 196g at an angle that reduces entrainment of the secondary gas 140g into the plasma arc 30. Similarly, the secondary gas 150g exits the secondary gas exit orifice 197g at an angle that reduces entrainment of the secondary gas 150g into the plasma arc 30. In one embodiment, the secondary gas 150g exits the secondary gas exit orifice 197g at an angle of about 0° relative to the longitudinal axis 31 of the plasma arc 30 and the secondary gas 140g exits the secondary gas exit orifice 196g at an angle of about 0° relative to the longitudinal axis 31. The fluid passageway 192g has a diameter that is larger relative to the diameter of the fluid passageway 193g. While the cross section of the torch tip 100 in FIG. 7 shows two fluid passageways 192g, 193g, any suitable number of fluid passageways or secondary gas passages may be employed. The number and/or size of each secondary gas passage or fluid passageway may be selected according to the specific application.

In FIG. 7, the secondary gas 140g, 150g flows through the secondary gas exit orifice 196g, 197g at an angle relative to the longitudinal axis 31 of the plasma arc 30 in a manner similar to the secondary gas in FIGS. 2C and 6B. The torch tip 10 shown in FIG. 7 is a non-limiting example and any of a number of torch, torch tip, and/or exit orifice configurations that provide the angle of secondary gas flow 40b, 50b (see FIG. 2C) and 40g, 50g (see FIG. 6B) relative to the plasma arc 30 may be employed in accordance with this invention.

Referring now to FIGS. 1A and 6C, each of the secondary gas streams 40h, 50h flow through a secondary gas exit orifice such that each of the secondary gas streams 40h, 50h intersects the longitudinal axis 31 of the plasma arc 30 at an angle of from about 40° to about 50°. Each of the secondary gas streams 40h, 50h flows through a secondary gas passage 92h, 93h and exits a secondary gas exit orifice.

Referring now to FIGS. 1A and 6C, each of the secondary gas streams 40h, 50h flow through a secondary gas exit orifice at an angle of from about 40° to about 50° relative to the longitudinal axis 31 of the plasma arc 30. Each of the secondary gas streams 40h, 50h flows through a secondary gas passage 92h, 93h and exits a secondary gas exit orifice. In accordance with this embodiment, the secondary gas streams 40h, 50h provide a converging angular flow with respect to the plasma arc 30.

Referring now to FIGS. 1A and 6D, each of the secondary gas streams 40i, 50i flow through a secondary gas exit orifice at an angle of from about −40° to about −50° relative to the longitudinal axis 31 of the plasma arc 30. Each of the secondary gas streams 40h, 50h flows through a secondary gas passage 92i, 93i and exits a secondary gas exit orifice. In accordance with this embodiment, the secondary gas streams 40i, 50i provide a diverging angular flow with respect to the plasma arc 30.

Referring now to FIGS. 1A and 6E, each of the secondary gas streams 40j, 50j flow through a secondary gas exit orifice at an angle of from about 80° to about 90° relative to the longitudinal axis 31 of the plasma arc 30. Each of the secondary gas streams 40j, 50j flows through a secondary gas passage 92j, 93j and exits a secondary gas exit orifice.

Referring now to FIGS. 1A and 6F, each of the secondary gas streams 40k, 50k flow through a secondary gas exit orifice at an angle relative to the longitudinal axis 31 of the plasma arc 30. The secondary gas stream 40k exits the secondary gas passage 92k at an angle of from about −40° to about −50° relative to the longitudinal axis 31 of the plasma arc 30. The secondary gas stream 50k exits the secondary gas passage 93k at an angle of from about 40° to about 50° relative to the longitudinal axis 31 of the plasma arc 30. In accordance with this embodiment, the secondary gas stream 40k provides a diverging angular flow with respect to the plasma arc 30 and the secondary gas stream 50k provides a converging angular flow with respect to the plasma arc 30.

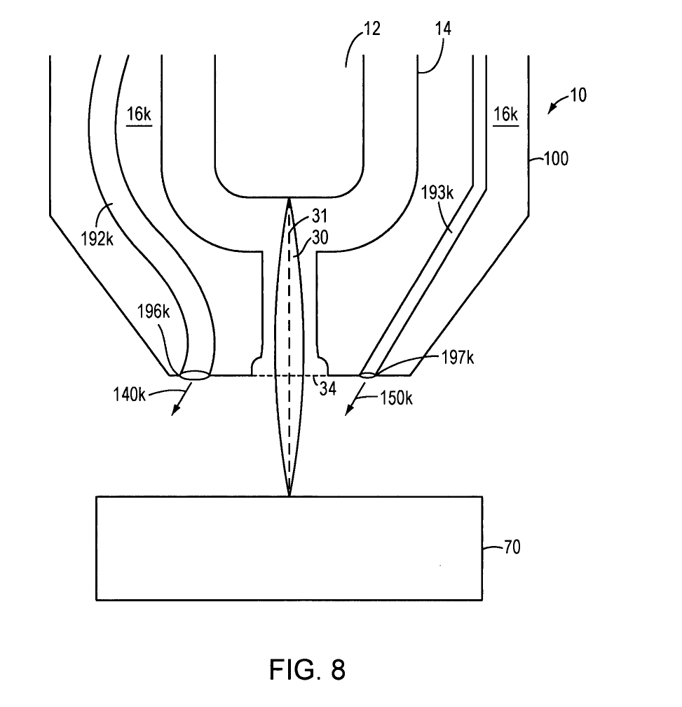

FIG. 8, illustrates an embodiment of a tip 100 of a plasma arc torch 10 where the secondary gas streams 140k, 150k flow through secondary gas passages 192k, 193k and exit secondary gas exit orifices 196k, 197k, respectively. Secondary gas 140k exits orifice 196k at an angle of from about −40° to about −50° relative to the longitudinal axis 31 of the plasma arc 30. The secondary gas 150k exits orifice 197k at an angle of from about 40° to about 50° relative to the longitudinal axis 31 . Referring still to FIG. 8, the components of the torch tip 100 include the nozzle 14, which includes a nozzle body 16k, fluid passageways 192k, 193k disposed in the nozzle body 16K that are secondary gas passages 192k, 193k and a plasma exit orifice 34. The plasma arc 30 exits the plasma exit orifice 34. Each secondary gas passage 192k, 193k (i.e., fluid passageway) includes a secondary gas exit orifice 196k, 197k, respectively. The secondary gas 140k exits the secondary gas exit orifice 196k at an angle that reduces entrainment of the secondary gas 140k into the plasma arc 30. Similarly, the secondary gas 150k exits the secondary gas exit orifice 197k at an angle that reduces entrainment of the secondary gas 150k into the plasma arc 30. In one embodiment, the secondary gas 150k exits the secondary gas exit orifice 197k at an angle of about 45° relative to the longitudinal axis 31 of the plasma arc 30 and the secondary gas 140k exits the secondary gas exit orifice 196k at an angle of about −45° relative to the longitudinal axis 31.

The fluid passageway 192k exit orifice 196k has a diameter that is similar relative to the diameter of the fluid passageway 193k exit orifice 197k. While the cross section of the torch tip 100 in FIG. 8 shows two fluid passageways 192k, 193k, any suitable number of fluid passageways or secondary gas passages may be employed. The number and/or size of each secondary gas passage or fluid passageway may be selected according to the specific application (e.g., the workpiece 70 material, for example).

In FIG. 8, the secondary gas 140k, 150k flows through the secondary gas exit orifice 196k, 197k at an angle relative to the longitudinal axis 31 of the plasma arc 30 in a manner similar to the secondary gas in FIG. 6F. The torch tip 10 shown in FIG. 8 is a non-limiting example and any of a number of torch, torch tip, and/or exit orifice configurations that provide the angle of secondary gas flow 40k, 50k (see FIG. 6F) relative to the plasma arc 30 may be employed in accordance with this invention.

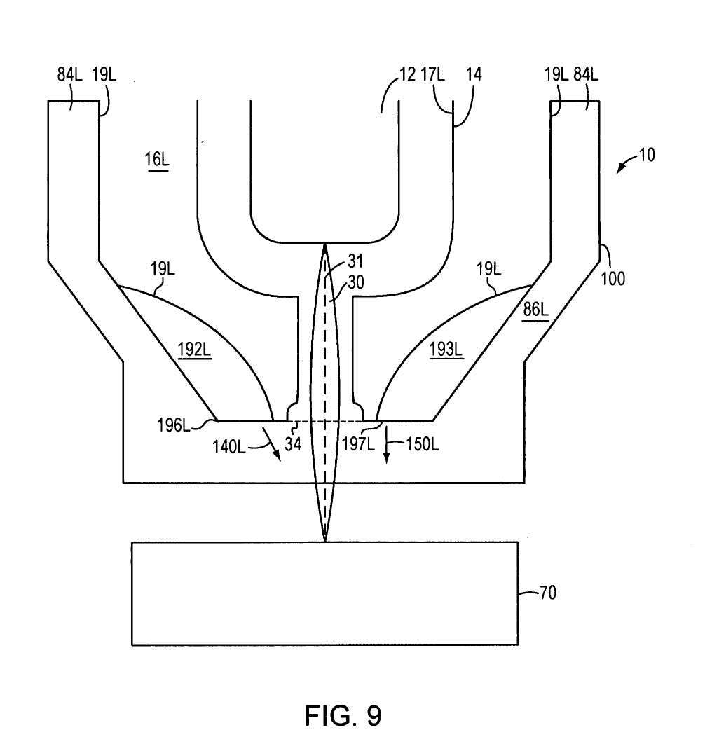

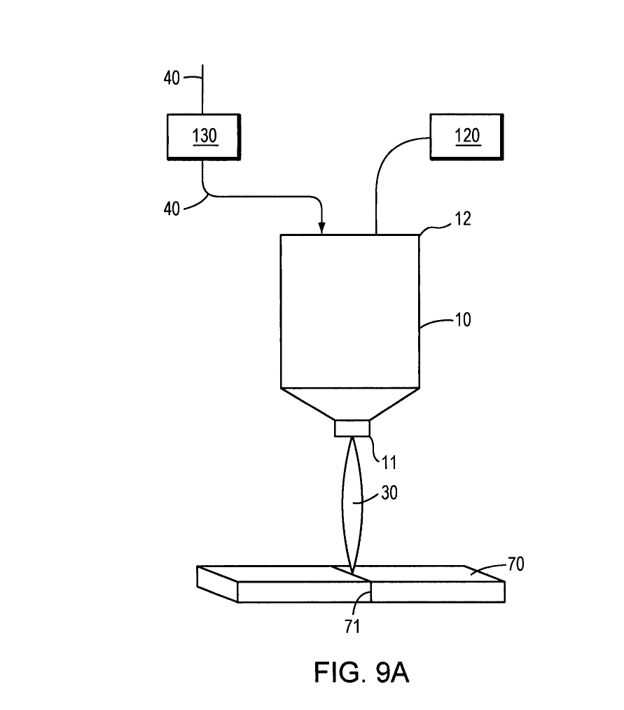

FIG. 9, illustrates an embodiment of a tip 100 of a plasma arc torch 10 where the secondary gas streams 140L, 150L, flow through the secondary gas exit orifice 196L, 197L at an angle relative to the longitudinal axis 31 of the plasma arc 30. The secondary gas 140L exits orifice 196L at an angle having a value ranging from about 20° to about 30°. The secondary gas 150L exits orifice 197L at an angle having a value ranging from about 0° to about −10°. Referring still to FIG. 9, the components of the torch tip 100 include the nozzle 14, which includes a nozzle body 16L, a nozzle exterior 19L, and a plasma exit orifice 34. A plasma arc 30 is drawn across a space between the electrode 12 and the nozzle 14. The plasma arc 30 exits the plasma exit orifice 34. A secondary cap 84L has a body 86L. The secondary cap 84L is mounted in a circumscribing relationship to the nozzle 14, but not a spaced relationship. As depicted, the secondary cap 84L cooperates with the nozzle 14 exterior 19L to form fluid passageways 192L, 193L. The fluid passageways provide secondary gas passages 192L, 193L each including a secondary gas exit orifice 196L, 197L, respectively. The secondary gas 140L exits the secondary gas exit orifice 196L at an angle that reduces entrainment of the secondary gas 140L into the plasma arc 30. Similarly, the secondary gas 150L exits the secondary gas exit orifice 197L at an angle that reduces entrainment of the secondary gas 150L into the plasma arc 30.

In one embodiment, the secondary gas has from about 0.01% to about 99.9% helium, from about 0.1% to about 50% helium, from about 1% to about 30% helium, from about 5% to about 30% helium, from about 20% to about 80% helium, or from about 30% to about 65% helium. The secondary gas can further include an oxidizing gas, for example.

The method can also include a step of controlling the temperature of the secondary gas. For example, the temperature of the secondary gas is controlled prior to when the secondary gas contacts the plasma arc. In one embodiment, the temperature of the secondary gas is selected to provide a gas density of the secondary gas that is substantially similar to the density of the plasma arc generated by the torch. The secondary gas temperature can be controlled by, for example, an external heating source or cooling source. Referring now to FIG. 9A a temperature controller 130 external to the plasma arc torch 10 controls the temperature of secondary gas 40 before the secondary gas 40 is introduced into the plasma arc torch. Optionally, suitable secondary gas temperature controllers can be incorporated into a plasma arc torch.

In another aspect, referring now to FIGS. 1A and 9A, the invention relates to a plasma arc torch 10. The plasma arc torch can include a torch body having a first end 11, a second end 11, and a plasma exit orifice 34 at the first end of the torch body. A plasma gas forms a plasma arc 30 that extends through the plasma exit orifice 34. A secondary gas passage includes a secondary gas exit orifice at the first end of the torch body. The plasma arc torch includes a means for controlling a secondary gas to provide a secondary gas that reduces entrainment of the secondary gas exiting the secondary gas exit orifice into the plasma gas. In one embodiment, the means for controlling controls the secondary gas density to provide a secondary gas that reduces entrainment of the secondary gas and the plasma arc at a location external the plasma exit orifice 34. In another embodiment, the means for controlling controls the density of the secondary gas flowing through the secondary gas exit orifice to reduce a density differential between the secondary gas and the plasma gas at the secondary gas exit orifice. The means for controlling can control the density of the secondary gas flow to reduce the density differential between the plasma arc and the secondary gas flow when the secondary gas flow contacts the plasma arc. In one embodiment, the means for controlling the secondary gas is a temperature controller for controlling the temperature of the secondary gas. Alternatively, or in addition, the means for controlling the secondary gas includes two or more valves for mixing two or more secondary gases selected from the group of Helium, Nitrogen, Oxygen, Hydrogen, Argon, Methane, and Carbon Dioxide. The means for controlling the secondary gas can be a controller for controlling a ratio of two or more secondary gases. In another embodiment, the means for controlling the secondary gas includes directing the flow of the secondary gas through the secondary gas exit orifice at an orientation that reduces entrainment of the secondary gas into the plasma gas. For example, the secondary gas flows through the secondary gas exit orifice at an angle that minimizes entrainment of the secondary gas into the plasma arc.

The torch body of the plasma arc torch 10 can connect to a power supply 120 to provide a plasma arc torch system. The plasma arc 30 cuts through the workpiece 70 at cut 71. Any of the above described plasma arc torches and torch tips can be employed in a plasma arc torch system of FIG. 9A. The examining the efficacy of the disclosed system, apparatus, and method, a series of experiments were conducted, which are discussed in detail below.

### EXAMPLE 1

The experimental results demonstrate that introducing a secondary gas mixture including helium improves plasma arc torch cut quality. Cut quality is measured by surface roughness, top dross and top edge rounding, these measures are all reduced when the secondary gas includes helium and the secondary gas including helium flows at an angle that reduces entrainment of the secondary gas into the plasma arc.

Experiments were performed in which ⅜″ mild steel was cut using a plasma arc torch with various secondary gas mixtures of oxygen, nitrogen, argon, and helium. Plasma has a very low density and a high thermal conductivity. Both argon and helium are chemically inert gases that are not expected to chemically react with the surface of the workpiece. However, helium and argon have different density values, thermal conductivity values, and atomic weights. Helium has larger thermal conductivity and a lower density than argon. Specifically, Helium has a thermal conductivity of 1.411 mW/(cm*K) at a temperature of 273.2 Kelvin and at 1 atm and Helium has a density of 0.17847 g/L at 0° C. Argon has a thermal conductivity of 0.1619 mW/(cm*K) at a temperature of 270 Kelvin and at 1 atm and Argon has a density of 1.7824 g/L at room temperature (approximately 25° C.). While not being bound to any single theory, but as appears to be established by the experiment now disclosed, it is believed that because both helium and plasma have relatively low density values, a secondary gas mixture including the low density helium gas reduces the rate of mixing between the plasma and the secondary gas. In addition, because helium has a high thermal conductivity it increases heat transfer when the plasma cuts the workpiece surface.

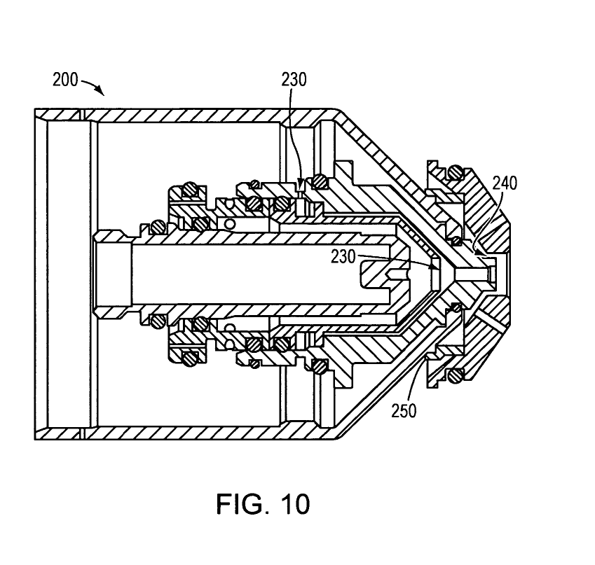

The experiments employ a plasma arc torch with a co-axial secondary cap or co-axial shield design, specifically, the experiments were performed using a Hypertherm HD4070 system (Hanover, New Hampshire) with a HyPerformance torch and consumable parts designed with a vented nozzle and a co-axial shield. FIG. 10 shows a schematic of the plasma arc torch 200 employed in the experiment. The secondary gas is swirled by a secondary gas swirl ring 250. After the secondary gas passes through the swirl ring 250 the secondary gas stream has at least three directional components: a secondary gas swirl component, a secondary gas axial component, and a secondary gas radial component. The co-axial shield design 240 provides secondary gas (e.g., a combination of the secondary gas axial component and the secondary gas radial component) at an angle that reduces entrainment of the secondary gas into the plasma arc (e.g., the co-axial shield design provides the secondary gas at an angle measuring about 0° relative to the longitudinal axis of the plasma arc). In addition, the co-axial shield design 240 provides a plasma arc and a secondary gas at an angle and/or at relative velocities that reduce and/or minimize entrainment of the secondary gas into the plasma arc.

In the experiment, 3 inch square samples of ⅜ inch thick mild steel were cut using a Hypertherm HD4070 system (Hanover, N.H.) with a HyPerformance torch 200 and consumable parts designed with a vented nozzle 230 and a co-axial shield 240. A cutting speed of 150 inches per minute and a torch standoff of 0.130 inches was used for all of the experiments. The HD4070 gas console plasma gas settings were 12% O₂ and 35% N₂ for the plasma pre-flow and 72% O₂ for the plasma cut-flow. The HD4070 software was modified to activate both the secondary gas pre-flow and cut-flow valves such that both the pre-flow and the cut flow valves are active when the plasma arc torch is operational. As such, the pre-flow and cut flow both impact the overall flow rate of the secondary gas when the plasma arc torch 200 is operational during cutting. Table 1, below shows the gas console secondary gas settings for the seven tests conducted.

TABLE 1
Secondary Gas Selection and Gas Console Flow Settings

| | Gas Type | | | | Secondary Gas Flow Setting (%) | | | |
|---|---|---|---|---|---|---|---|---|
| | Pre | | Second | Second | Pre | | Second | Second |
| Test | Second | Pre Second | Cut | Cut | Second | Pre Second | Cut | Cut |
| 1 | O2 | N2 | O2 | N2 | 90 | 0 | 90 | 0 |
| 2 | O2 | N2 | O2 | N2 | 90 | 0 | 90 | 10 |
| 3 | O2 | N2 | O2 | N2 | 90 | 10 | 90 | 10 |
| 4 | O2 | Ar | O2 | Ar | 90 | 10 | 90 | 0 |
| 5 | O2 | He | O2 | He | 90 | 10 | 90 | 0 |
| 6 | O2 | He | O2 | He | 90 | 10 | 0 | 0 |
| 7 | O2 | He | O2 | He | 90 | 30 | 0 | 0 |

The test 1 cut sample had a sharp top edge and no dross but had large cut angles with excessive curvature. The test 2 cut sample had a sharp top edge with small angles and very little dross. The test 3 cut sample had sharp top edges and had dross on all three sides. The results from test 1-3 show that for an O₂/N₂ shield gas mixtures small amounts of nitrogen can reduce cut angles and edge curvature and increasing the nitrogen level leads to increased dross levels.

In test 4 argon was used in the secondary gas pre-flow mixture. The test 4 cut sample was very poor exhibiting large cut angles, no top dross with well adhered bottom dross forming a solid lip on the bottom of the cut. The cut surface was oxidized at the top of the cut, while the bottom of the cut had no oxide layer.

In tests 5, 6 and 7 helium was used in the secondary gas mixture. All three tests exhibited very smooth cut surfaces with uniform layers of oxide, no top dross, very sharp top edges and some edge curvature. Also, all three samples had some loosely attached dross beads on the bottom.

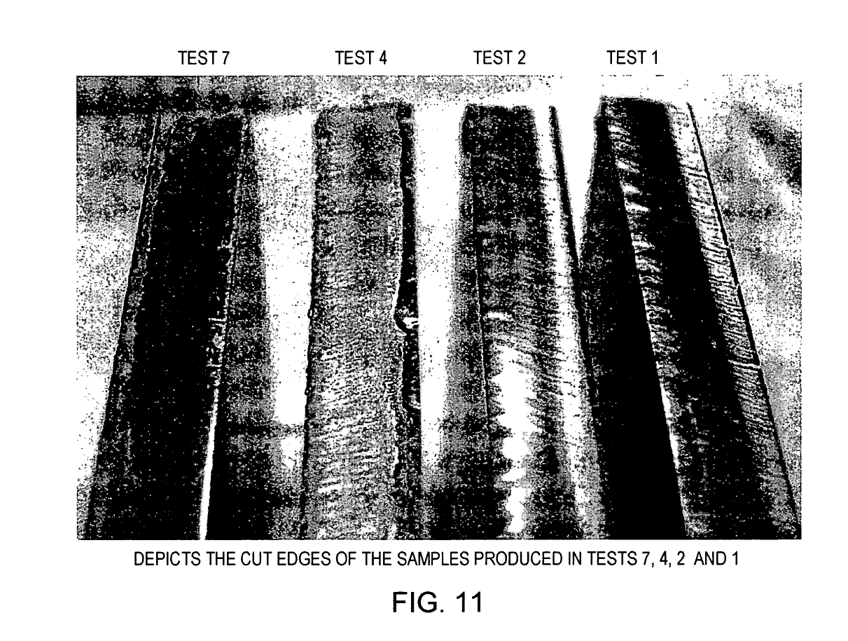

FIG. 11 depicts the cut edges of the samples produced in tests 7, 4, 2, and 1. The results of test 7 are desirable. The test results demonstrate a strong correlation between the shield gas composition and the quality of the cut sample produced. Small amounts of nitrogen in oxygen reduce the cut angle and edge curvature (see, Test 2 in Table 1 and in FIG. 11).

Cuts produced with a secondary/shield gas mixture of oxygen and the inert gas helium produce cut samples with very smooth cut edges and very sharp top edges (see, Test 7 in Table 1 and in FIG. 11). However, substituting argon, another inert gas, for nitrogen (see, Test 4 in Table 1 and in FIG. 11) does not provide a cut edge benefit. Without being bound to any single theory, it is believed that the difference between the lack of cut benefit with a secondary gas including argon versus a secondary gas including helium is due to the higher density and lower thermal conductivity of argon relative to helium. Helium appears to be a particularly effective shield gas additive. It appears that the density of helium, which, like plasma, is relatively low, the high thermal conductivity of helium, and chemical stability of helium, an inert gas, make it a particularly effective shield gas additive. Flowing secondary gas comprising helium at an angle the reduces entrainment of the secondary gas into the plasma gas in a plasma arc torch system provides improved cut quality not realized when secondary gases comprising nitrogen and/or argon are employed.

The addition of helium could improve the cut performance of a wide variety of plasma cutting processes designed to cut any material. Further, the addition of a secondary gas containing helium at an angle that reduces entrainment of the secondary gas into the plasma arc can also provide improved cut quality.

In addition, secondary gas mixtures can also include mixtures of oxygen, nitrogen, and helium. It is expected that a secondary gas mixture of nitrogen, helium, and oxygen may limit the formation of dross and eliminate the edge curvature observed on the cut samples generated where the secondary gas includes a mixture of helium and oxygen alone.

### EXAMPLE 2

In a second experiment, results demonstrate that introducing a secondary gas mixture including helium improves the quality of holes cut into mild steel by a plasma arc torch. Through holes cut into a metal material by a plasma arc torch can taper at one end of the through hole. Through holes are made in metal material to enable bolts to be secured to the material. Tapering in through holes causes issues including difficulty in cylinder/cutting clearance and issues in the field including difficulty affixing bolts through a through hole in a material. The thickness of the material through which a through hole is cut also impacts the through hole quality. Tapering in through holes is analogous to top edge rounding in an application where a substantially linear cut is being made. Imperfections in through hole quality is magnified where a through hole has a small diameter, because, for example, the impact of tapering can impact the usability of a through hole (for example, the ability to affix a bolt through a through hole) where a through hole has a small diameter. For example, as the diameter to length ratio of a through hole approaches a one to one ratio imperfections in the through hole are magnified.

Through holes are cut into a ¼″ mild steel plate using a plasma arc torch with air as a secondary gas and with a secondary gas mixture of oxygen, nitrogen, and helium. In the experiment, samples of ¼ inch thick mild steel are cut using a Hypertherm HPR260 system with a prototype shield gas mixing system similar to the shield gas mixing system shown in FIG. IC (Hanover, N.H.) with a HPR Torch and HPR80A mild steel consumable parts. A cutting speed of 50 inches per minute and a torch standoff of 0.080 inches was used in this experiment.

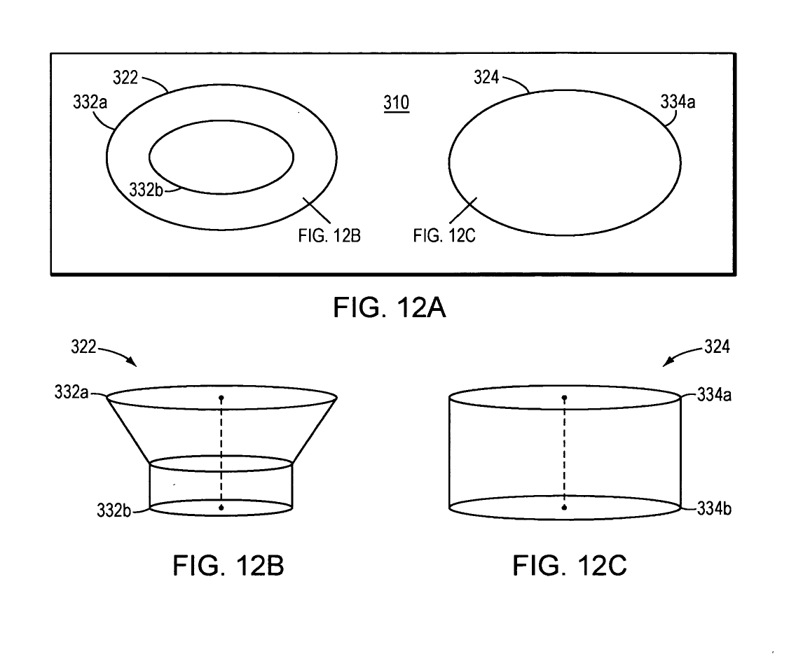

FIGS. 12A-12C show a schematic of ¼″ mild steel material 310 and the through holes 322 and 324 that are cut through the material 310. The through hole 322 is cut with above-described plasma arc torch. The plasma gas flowing through the torch contains oxygen and the secondary gas is air. Referring now to FIG. 12C, the top 332a of through hole 322 has an average diameter measuring 0.336 inches and the bottom 332b of through hole 322 has an average diameter measuring 0.250 inches.

Referring now to FIGS. 12A-12C, the through hole 324 is also cut with above-described plasma arc torch. The plasma gas flowing through the torch contains oxygen and the secondary gas is a mixture of 50% Helium gas, 45% oxygen gas,. and 5% nitrogen gas. Referring now to FIG. 12C, the top 334a of through hole 324 has an average diameter measuring 0.248 inches and the bottom 334b of through hole 324 has an average diameter measuring 0.250 inches.

Through hole 324, which employs a secondary gas mixture including helium, has reduced taper compared to through hole 322, which does not employ helium. The improvement in cut quality of through hole 324 compared to through hole 322 is indicative of a reduction in the negative effects of entrainment that results from the secondary gas mixture (i.e., 50% Helium gas, 45% oxygen gas,. and 5% nitrogen gas) employed to cut through hole 324 as compared to the secondary gas mixture (i.e., air) employed to cut through hole 322. In addition, the secondary gas mixture employed to cut through hole 324 has a density at ambient conditions that is less than the density of nitrogen gas at ambient conditions. More specifically, the secondary gas employed to cut through hole 324 has a density at ambient conditions that is less than about 70% of the density of nitrogen at ambient conditions. In addition, the controlled secondary gas flow having a secondary gas density that reduces entrainment of the secondary gas into the plasma gas that forms a plasma arc that is employed to cut through hole 324 provides a more consistent hole cut than the secondary gas flow that is employed to cut through hole 322.

Based on the experimental data a reduction in top edge rounding, which reduces tapering in the holes, appears to be due to the use of the inert gas, namely helium. The improvement achieved by reduced entrainment appears to be due to the lower density of the secondary gas which in this experiment was provided by using a mixture including helium, a gas having a relatively low density.

While the invention has been particularly shown and described with reference to specific preferred embodiments, it should be understood by those skilled in the art that various changes in form and detail may be made therein without departing from the spirit and scope of the invention. Variations, modifications, and other implementations of what is described herein will occur to those of ordinary skill without departing from the spirit and the scope of the invention. Accordingly, the invention is not to be defined only by the preceding illustrative description.

What is claimed is:

1. A method of controlling a secondary gas that exits a secondary gas passage exit orifice at an end of a plasma arc torch body, the method comprising:
controlling the flow of a secondary gas to provide a secondary gas density that reduces entrainment of the secondary gas into a plasma gas that forms a plasma arc.

2. The method of claim 1 wherein the secondary gas comprises at least about 20% helium.

3. The method of claim 1 wherein the density of the secondary gas at ambient conditions is less than the density of Nitrogen gas at ambient conditions.

4. The method of claim 1 wherein the density of the secondary gas at ambient conditions is less than about 70% of the density of Nitrogen at ambient conditions.

5. The method of claim 1 wherein controlling the secondary gas comprises controlling the secondary gas temperature.

6. The method of claim 1 wherein controlling the flow of the secondary gas comprises providing a secondary gas density that minimizes entrainment of the secondary gas into the plasma gas.

7. A plasma arc torch system comprising:
a torch body having a first end and a second end;
a plasma exit orifice at the first end of the torch body, a plasma arc ejects from the plasma exit orifice;
a secondary gas passage including a secondary gas exit orifice at the first end of the torch body; and
a control means for controlling the secondary gas to reduce entrainment of the secondary gas and the plasma arc at a location external to the plasma exit orifice.

8. The plasma arc torch system of claim 7 wherein the control means comprises a temperature controller.

9. The plasma arc torch system of claim 7 wherein the control means comprises a flow control module for mixing two or more gases to provide a secondary gas density that reduces entrainment of the secondary gas and the plasma arc at a location external to the plasma exit orifice.

10. The plasma arc torch system of claim 7 wherein the secondary gas is substantially columnar to the plasma arc.

11. The plasma arc torch system of claim 7 wherein the secondary gas passage comprises one or more fluid passageway in a nozzle.

12. The plasma arc torch system of claim 7 wherein the control means comprises a flow control module for providing a secondary gas having at least 20% helium.

13. The plasma arc torch system of claim 7 wherein the plasma exit orifice is the smallest diameter through which a plasma gas passes in the torch body.

14. The plasma arc torch system of claim 7 wherein the secondary gas passage comprises one or more fluid passageway in a nozzle.

15. The plasma arc torch system of claim 14 wherein the one or more fluid passageway defines a path of at least a portion of the secondary gas exiting the secondary gas exit orifice and the path is substantially parallel to the plasma arc.

16. A method of operating a plasma arc torch having a nozzle including a plasma exit orifice and having a secondary gas passage including a secondary gas exit orifice, the method comprising:
flowing a plasma gas to form a plasma arc that extends through the plasma exit orifice; and
controlling the density of a secondary gas flowing through the secondary gas exit orifice to reduce a density differential between the secondary gas and the plasma gas at the secondary gas exit orifice.

17. The method of claim 16 wherein the secondary gas comprises a mixture of two or more gases.

18. The method of claim 16 wherein the secondary gas comprises at least about 20% helium.

19. The method of claim 16 wherein the density of the secondary gas at ambient conditions is less than the density of Nitrogen gas at ambient conditions.

20. The method of claim 16 wherein the density of the secondary gas at ambient conditions is less than 70% of the density of Nitrogen gas at ambient conditions.

21. The method of claim 16 wherein controlling the density of the secondary gas comprises controlling the secondary gas temperature.

22. The method of claim 16 wherein the secondary gas is substantially coaxial to the plasma gas.

23. The method of claim 16 wherein controlling the density of the secondary gas comprises flowing through the secondary gas exit orifice a secondary gas to minimize the density differential between the secondary gas and the plasma gas at the secondary gas exit orifice.

24. A system for cutting a material with a plasma arc torch, the system comprising:
a torch that generates a plasma arc from a plasma gas flow, the plasma arc extends through a plasma exit orifice, the torch having a secondary gas flow that contacts the plasma arc; and
a controller for controlling the density of the secondary gas flow to reduce the density differential between the plasma arc and the secondary gas flow when the secondary gas flow contacts the plasma arc.

25. The system of claim 24 wherein the secondary gas flow is substantially parallel to the plasma arc.

26. The system of claim 24 wherein the controller controls the plasma gas flow to the torch;

27. The system of claim 24 wherein the controller comprises a heater.

28. The system of claim 24 wherein the controller maintains the temperature of the secondary gas flow.

29. The system of claim 24 wherein the controller provides a secondary gas flow having at least about 20% helium.

30. The system of claim 24 wherein the material comprises aluminum or stainless steel and the secondary gas comprises nitrogen and at least about 20% helium.

31. A system for cutting a material with a plasma arc, the system comprising:
a torch that generates a plasma arc from a plasma gas flow, the torch having a secondary gas flow that contacts the plasma arc at a location about an end of the torch; and
a heater for controlling the temperature of the secondary gas flow to reduce entrainment between the secondary gas flow and the plasma arc before the secondary gas flow contacts at least a portion of the plasma arc.

32. The system of claim 31 wherein the secondary gas flow is substantially coaxial to the plasma arc.

33. The system of claim 31 wherein the heater is external to the torch.

34. A method for operating a plasma arc torch, the method comprising:
generating a plasma cutting arc with a plasma gas in a plasma arc torch;
contacting a secondary gas with the plasma gas at a location about an end of the plasma arc torch; and
controlling the secondary gas to reduce the difference between the plasma gas density and the secondary gas density, wherein the secondary gas density at ambient conditions is less than the density of Nitrogen gas at ambient conditions and the secondary gas comprises at least 20% of an inert gas.

35. The method of claim 34 wherein the inert gas is Helium.

36. The method of claim 34 wherein the secondary gas density at ambient conditions that is less than about 70% of the density of Nitrogen at ambient conditions.

37. The method of claim 34 wherein the secondary gas comprises between about 30% and about 60% Helium.

38. The method of claim 34 wherein controlling the secondary gas comprises controlling the secondary gas temperature.
